(19) United States
(12) Patent Application Publication
(10) Pub. No.: US 2018/0152751 A1
(43) Pub. Date: May 31, 2018

(54) System and Method for Enhanced Media Presentation

(71) Applicant: Rickie Taylor, Spring Valley, NY (US)

(72) Inventor: Rickie Taylor, Spring Valley, NY (US)

(21) Appl. No.: 15/361,542

(22) Filed: Nov. 28, 2016

(51) Int. Cl. H04N 21/436; H04N 21/61; H04N 21/431; H04N 21/234; G06K 9/00

(52) U.S. Cl. CPC H04N 21/436; H04N 21/6125; G06K 9/00744; H04N 21/23418; H04N 21/4312

(57) ABSTRACT

A media presentation method includes providing media content to at least one user on a primary media device, the content comprising at least one character engaging in an activity within a primary scene; transitioning the at least one character from the primary scene; selecting the at least one character via an input mechanism prior to the transition; and providing media content associated with the selected at least one character within a secondary scene on a secondary media device while simultaneously presenting content not including the transitioned character on the primary device.

### BACKGROUND

The present disclosure is directed to media presentation and more particularly to providing multiple simultaneous media presentations based on user preferences.

Traditional audio visual (A/V) content presentation has been facilitated by a television (TV). For the most part, the viewers are a captive audience and directed their focus to the content being presented on the TV.

In a typical movie or TV show for example, a scene could consist of one or more characters (actors, actresses, etc.) acting in their respective role(s). As the scene changes, one or more of the characters may leave the scene and no longer be visible to the viewer. This is similar to a performer exiting the stage in a live performance (such as in a play or a musical).

Increasingly, younger generation of viewers (or users) spread their attention, sometimes simultaneously, among multiple media devices each potentially presenting disparate, unrelated content. The devices can include, in addition to a TV, desktop computers, mobile phones such as smartphones and portable computing devices such as laptop computers and tablets. A typical viewer may watch TV while web browsing, texting, video chatting, etc. The media presented via the TV can also be presented via a smartphone or a tablet.

Exemplary embodiments utilize the multiple devices to enhance the user/viewer media experience by providing different content simultaneously on different devices based on the user/viewer preferences.

### SUMMARY

According to an exemplary embodiment, a media presentation method is disclosed. The method comprises: providing media content to at least one user on a primary media device, the content comprising a plurality of characters engaging in an activity within a primary scene; selecting a character via an input mechanism prior to transition of the character from the scene; transitioning the character from the primary scene; and providing media content associated with the selected character within a secondary scene on a secondary device while simultaneously presenting content not including the transitioned character on the primary device.

According to another exemplary embodiment, an audio visual (A/V) content presentation system is disclosed. The system comprises: a server having primary and secondary audio visual content, the content corresponding to a plurality of characters engaged in activity associated with their assigned roles in a performance; a plurality of user devices receiving the content from the server, the user devices including a primary device and a plurality of secondary devices; a communication interface for connecting the server to the plurality of user devices; a controller for instructing the server to provide the content to the user devices, wherein the primary content is displayed on the primary user device, the primary content corresponding to an activity of at least one character in a scene, and the secondary content is selectively displayed on at least one of the secondary user devices based on user selection, wherein the secondary content corresponds to an activity of the at least one character away from the scene.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a character transition from a scene according to exemplary embodiments;

FIG. 2 illustrates a system in accordance with exemplary embodiments; and

FIG. 3 illustrates a method in accordance with exemplary embodiments.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the exemplary embodiments.

Reference throughout this specification to an “exemplary embodiment” or “exemplary embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

According to exemplary embodiments, users can choose to follow characters and their activities as the characters exit a scene. The exiting characters may engage in off-scene activity that could provide a background to subsequent scenes for example.

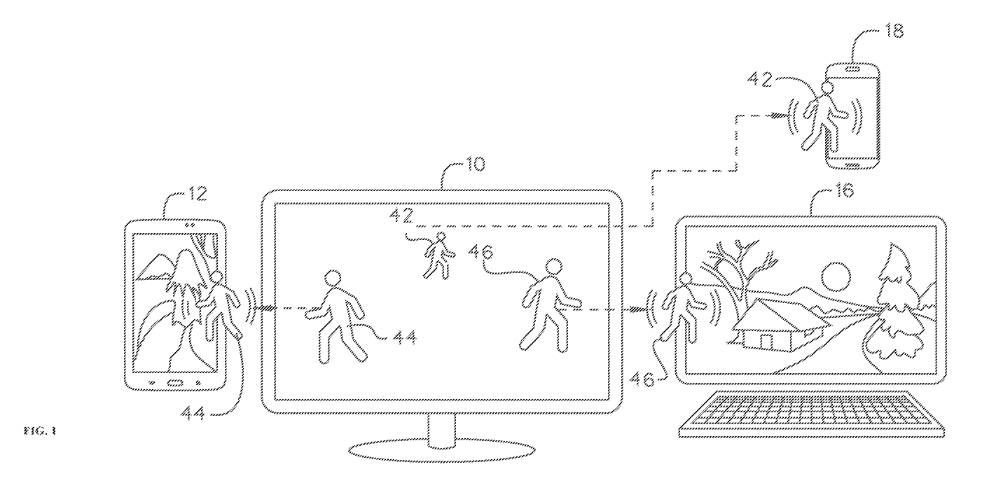

As illustrated in FIG. 1, characters 42, 44 and 46 may leave a scene as specified by the script of the show or performance in which they are acting (“activity”). A TV or monitor can be referred to as primary device 10. The characters can leave at the same time or at different times. As the characters leave the scene, other characters can act out their role in a similar or a different scene which is displayed on the primary device 10.

If a (first) viewer is interested in following the “off-scene” activity of character 42, the viewer can indicate this preference by selecting or highlighting character 42 on the primary device 10 (prior to character 42 exiting the scene). The activity of character 42 away from the primary device 10 (i.e. off-scene) can then be presented to the viewer on a secondary or supplemental device such as smartphone 18. Similarly, the (off-scene) activity of character 46 can be followed on a supplemental device such as laptop 16. The (off-scene) activity of character 44 can be followed on another device such as another smartphone 12.

Each of devices 12, 16 and 18 may be associated with one or more viewers. That is, all three of the devices can be associated with one viewer. Two of the devices can be associated with one viewer and the third device can be associated with a second viewer. Each device can also be associated with one user. One of the devices can also be associated with multiple viewers, etc.

Exemplary embodiments need not be limited to following characters from a primary to a secondary or supplemental device. Objects or animals can also be followed from primary to secondary devices. Objects can be moving such as cars, buses, trains, planes, boats, etc. In some embodiments, even scenes can be followed as the primary device scene shifts from one setting or background to another setting or background. A scene can be a precursor/lead-in scene prior to a character's transition into that scene.

Aspects of a character's (or an object's) activity or presence in a primary device may be associated with a timestamp. The timestamp may be a time of day, day of week, date of month, month of year, etc. The timestamp may also be the time that has elapsed from the beginning of a program.

If, for example, a character X leaves a scene (i.e. on a primary device) at time T1 (for example, at 11:45:23, the time of day) and re-enters the scene at time T2 (for example, at 12:02:19), activity associated with character X for the “missing” sixteen (16) minutes and fifty six (56) seconds (16:56) may be presented to the viewer on a secondary device which could be specified by the user or users. Character X's activity on supplemental or secondary device can also have an associated timestamp.

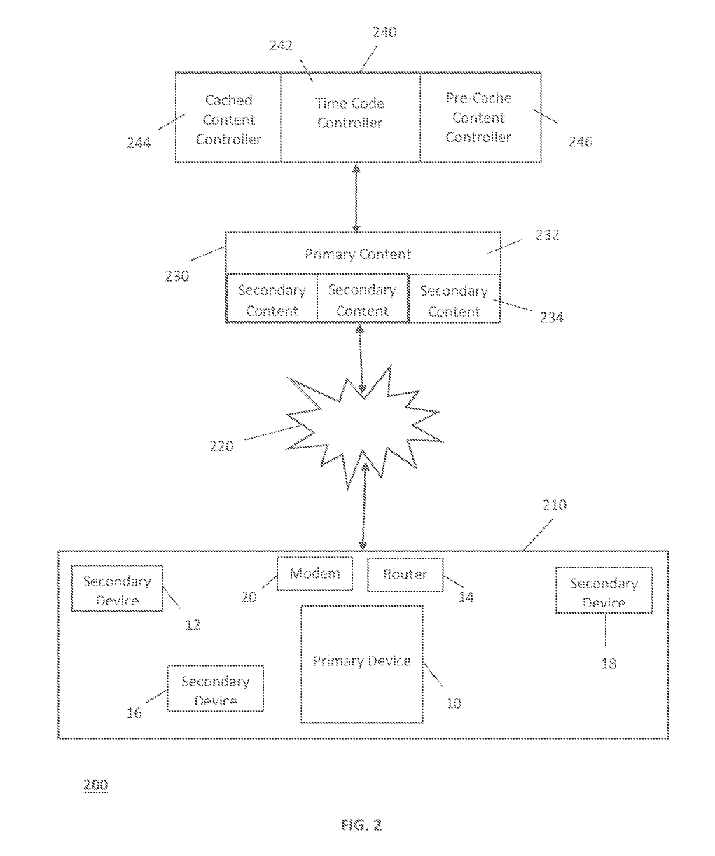

A system in accordance with exemplary embodiments is illustrated in FIG. 2. System 200 may include a user premises 210 within which the primary device 10 and secondary devices 12, 16 and 18 may be located.

Devices 10, 12, 16 and 18 may receive a combination of one or more of audio and visual content (i.e. A/V content in the form of images, sounds, video, etc.) from a content server 230 via interface 220. Content server 230 may have stored within, primary content 232 and secondary content 234. Three secondary content partitions are included for illustrative purposes—the actual number may vary depending on the number of characters associated with a particular program for example. Interface 220 may be an over the air interface receiving broadcast content, a satellite communication link, a cable network, a microwave link, a private network or a public network such as the internet for example.

Premises 210 may also include a router 14 for routing the content to one or more of the primary and secondary devices. The content may be provided to router 14 by a modem 20 if the data from server 230 is being received over a network for example. Modem 20 and router 14 may be separate units in some embodiments. In other embodiments, modem 20 may be integrated within router 14. The connection between the modem and router or between router and devices are not specifically illustrated. Devices 10, 12, 16 and 18 may have a wireless communication interface with router 14.

A controller may be implemented to facilitate exemplary embodiments as described. An exemplary system 200 may include controller 240 that communicates with content server 230. Controller 240, may have integrated or included within, a time code controller 242, a cached content controller 244 and a pre-cache content controller 246.

Controller 240 may determine the time at which secondary content is provided to a secondary device. The controller may also determine the specific secondary content that is to be provided as well as the specific secondary device to which the secondary content is to be provided.

The time code controller 242 may issue command(s) to the cached content controller (on the local server) 244 to send (i.e. transmit) content to secondary or supplemental device display 12, 16 or 18 based on user choice and the time at which a character exits the primary screen. The secondary content 234 may then be provided by server 230 to a secondary device.

Controller 240 may monitor or have knowledge (in a knowledge database for example) of the projected bandwidth available for “pushing” content to the secondary devices. Information corresponding to the bandwidth, device identity and device association with a particular user may also be received in real time from the user premises by controller 240 either directly or via server 230. Controller 240 thus may include a modem or a similar mechanism for facilitating the monitoring function (not illustrated).

Bandwidth variations can occur based on a number of factors including, for example, the type of interface 220, time of day, weather, etc. Controller 240 may also have pre-knowledge about the character(s) a particular user wishes to follow on the user's secondary device as the character exits the main scene. Controller 240 may also be able to identify a secondary device associated with a particular user.

Time code controller 242 may also issue command(s) to the pre-cache controller 246 to send content to secondary or supplemental device based on expected bandwidth unavailability (either reduction or lack of connection). If controller 242 anticipates potential bandwidth unavailability and has knowledge about a particular user's preference for following a particular character, controller 242 can provide an instruction to pre-cache content controller 246 to send secondary content 234 from server 230 to a secondary device.

In some embodiments, the secondary devices may also be accessible from the server over a mobile communication network. If the bandwidth over a cable or satellite communication interface is projected to be inadequate or unavailable, secondary content may be sent by pre-cache controller 246 over the mobile communication network to a secondary device. In some embodiments, user of the secondary device may be prompted to permit or reject (pre) reception of the secondary content. In some embodiments, the user may set the secondary device to automatically receive content over the mobile communication network.

The secondary content that is provided may correspond to a particular character preferred by a particular user. The secondary content may be sent to a secondary device associated with the particular user. The secondary content in this case may be sent even before the associated character goes off-scene.

Server 230, controller 240 and various elements within each of these devices are known. Each of these elements may include one or more of a processor, a memory, a communications bus, a modem, etc. Controller 240 may also be equipped with mechanisms for synchronization. As a character exits a scene and the character's activity is no longer visible on primary device 10, the controller may synchronize the secondary content associated with the character such that it appears seamlessly on one of secondary devices 12, 16 and 18.

The content on server (i.e. primary and secondary) may be indexed with specific time counter parameters.

Users may interact with primary device 10 via an associated remote control unit or another known form of input interface or via one of the secondary devices such as a smartphone.

A user may designate the character or object (currently on the primary device) that the user wishes to follow (on a supplemental device). The designation may be made by the pointing device. The user may navigate the pointing mechanism (such as a cursor or a light beam) of the input device onto a particular character and the character may be selected by known means. The user may also designate one or more characters or objects that the user wishes to follow on one or more supplemental devices. The user may recognize transition of a character by following the movement of the character in the scene (i.e. as the character is transitioning from the scene).

In some embodiments, as the user navigates the pointing mechanism (such as a cursor or a light beam) of the input device onto a particular character (such as character X for example), the time remaining for character X on the primary screen may be visible to the user.

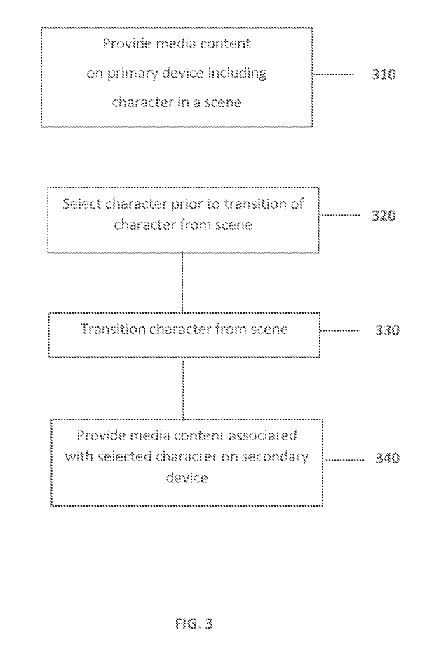

A method in accordance with exemplary methods may be illustrated with reference to FIG. 3. A user may be provided with media content at step 310. The media may be presented on a primary media device such as a TV. The content may comprise at least one character engaging in an activity within a primary scene. A user may select the character prior to transition at step 320 (i.e. as the character is transitioning from the scene). The selection may be made by an input device for example. The character may be transitioned from the scene at step 330. The transition of the character may occur as the storyline develops for example. Content associated with the selected character after the transition may be presented at step 340. The content may be presented to the user on a secondary media device for example. Concurrently, media content not including the transitioned character may be presented on the primary device.

Exemplary embodiments as described herein may supplement existing subscription to a television programming or movie service. Users can be provided with the option of paying additional fees to have access to the secondary content. In some embodiments, secondary content can be presented to the user concurrent or subsequent to presenting advertising content (i.e. without additional fees but advertising instead). The advertising can be presented on either or both of the primary and secondary devices. Advertising can also be presented on the secondary device while the user is watching on the primary device.

The applicability of exemplary embodiments as described herein are not limited to newly created content or programs. Existing (or even old) content or movies can be supplemented with background or off screen content. Such creation can be facilitated by known existing technology. Such ability to supplement even existing programs such as movies provides an opportunity for content creators to create such supplemental content.

Exemplary embodiments can gather user metrics from user activity, character choices, physical location etc. to present targeted and hyper personal advertising. For example, sports advertising can be presented based on a user choosing to follow an athlete's activity in and out of the primary and supplemental screens.

While the description has highlighted acting in a movie or a TV show, exemplary embodiments are not limited to these type of performances. Exemplary embodiments may equally be applicable in a sporting event. User premises need not be limited to a stationary location—they can be a moving location such as a ship, train, bus, etc.

Although exemplary embodiments have been disclosed, it will be apparent to those skilled in the art that various changes and modifications can be made which will achieve some of the advantages of embodiments without departing from the spirit and scope of the disclosure. Such modifications are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of presenting audio-visual (A/V) content, the method comprising:
displaying A/V content to at least one user on a primary device, the content comprising at least one character engaging in an activity within a primary scene;
selecting the at least one character being displayed on the primary device by a user via an input mechanism prior to transition of the character from the primary scene;
transitioning the at least one character from the primary scene to a secondary scene; and
displaying A/V content associated with the transitioned character within the secondary scene on a secondary device while simultaneously displaying A/V content not including the transitioned character on the primary device.

2. The method of claim 1, wherein the character is one of an actor, an animal, a mobile object and a stationary object.

3. The method of claim 1, wherein the primary device is one of a television, a desktop computer, a portable computing device and a mobile communication device.

4. The method of claim 1, wherein the secondary device is one of a television, a desktop computer, a portable computing device and a mobile communication device.

5. The method of claim 1, wherein the input mechanism is one of a mouse and a handheld pointing device.

6. The method of claim 5, further comprising:
associating a timer to the selected character wherein the timer indicates a time remaining prior to transition of the character from the scene.

7. The method of claim 1, further comprising:
transitioning the character to the primary scene.

8. The method of claim 7, further comprising:
transitioning activity associated with the character from the secondary device to the primary device.

9. The method of claim 1, further comprising:
transitioning a second character from the primary scene.

10. The method of claim 9, further comprising:
presenting content associated with the second character on a third device.

11. An audio-visual (A/V) content presentation system comprising:
a server having primary and secondary A/V content stored thereon, the content corresponding to a plurality of characters engaging in activity associated with their respective assigned roles in a performance;
a plurality of user devices receiving the A/V content from the server, the user devices including a primary device and a plurality of secondary devices;
a communication interface for connecting the server to the plurality of user devices;
a controller for instructing the server to provide the A/V content to the user devices, wherein
the primary A/V content is displayed on the primary user device, the primary content corresponding to an activity of at least one character in a primary scene, and
the secondary A/V content is selectively displayed on at least one of the secondary user devices based on a user selection of the at least one character on the primary device prior to a transition of the at least one character from the primary scene to a secondary scene, wherein
the secondary A/V content corresponds to an activity of the transitioned character in the secondary scene; and
the primary device simultaneously displays audio-visual content not associated with the transitioned character.

12. The system of claim 11, wherein the primary device is a television and the secondary devices are at least one of a desktop computer, a portable computer, a mobile communication device and a tablet.

13. The system of claim 11, wherein the communication interface is at least one of an over the air interface receiving broadcast content, a satellite communication link, a cable network, a microwave link, a private network and a public network.

14. The system of claim 11, wherein the communication interface is a mobile communication network.

15. The system of claim 11, wherein the controller comprises a monitor for receiving information relating to bandwidth, device identification and device association with a user.
